(19) United States
(12) Patent Application Publication
(10) Pub. No.: US 2022/0160564 A1
(43) Pub. Date: May 26, 2022

(54) PRESSURIZED ISOLATION UNIT

(71) Applicant: Saeplast Americas Inc., Saint John (CA)

(72) Inventors: Peter Triantafillou, Saint John (CA); Mark Beckwith, Saint John (CA)

(21) Appl. No.: 17/530,444

(22) Filed: Nov. 18, 2021

(30) Foreign Application Priority Data
Nov. 20, 2020 (CA) 3100152

(51) Int. Cl. A61G 10/00; A61G 10/02

(52) U.S. Cl. CPC A61G 10/005; A61G 2210/30; A61G 10/023

(57) ABSTRACT

The present invention is a pressurized isolation unit dimensioned to cover the head and thoraco-abdominal region of a patient. The unit has a filtered pressure system and a flexible abdominal binding cover that wraps around the patient's abdomen.

### FIELD OF THE INVENTION

The present invention relates generally to the field of protective medical equipment, and more particularly to pressurized isolation units.

### BACKGROUND OF THE INVENTION

When treating patients with contagious airborne pathogens, such as tuberculosis, measles, pertussis, chicken pox (Varicella Zoster), MERS (Middle East Respiratory Syndrome) or COVID-19, healthcare workers (HCWs) are put at risk of contracting the disease themselves. Aerosol generating medical procedures (AGMPs), such as aerosol treatments, puffer treatments, High Flow Nasal Cannula (HFNC OptiFlow™), certain non-invasive ventilation (NIV) modalities (such as Continuous Positive Airway Pressure (CPAP) and bi-level positive airway pressure (BiPAP)), lung bronchoscopy, intubation and extubation, are of particular concern as they allow for droplets containing virus or bacteria to become airborne.

Current standards for addressing this concern leave room for improvement. For example, when conducting intubation and extubation procedures, depending on the size of the room in which the procedure takes place, HCWs may wait approximately 20 to 35 minutes after each procedure for droplet particles to settle and for complete room air exchange to occur.

Recently developed intubation boxes, described in Tseng Y. J. and Lai H. Y. Protecting against COVID-19 aerosol infection during intubation. J Chin Med Assoc, May 4, 2020, provide HCWs with some level of protection from contagious airborne pathogens. However, since these intubation boxes leave the arm ports near the head of the bed open and also leave the abdominal area open, these intubation boxes cannot provide a negative pressure environment, meaning that the risk still exists that HCWs could contract a disease.

In particular, there is a need to improve the safety of the environment in which HCWs conduct procedures such as oxygen therapy (for e.g. via nasal cannula, such as high flow nasal cannula (HFNC OptiFlow™), Ventimask™, 100% non-rebreather mask, CPAP, BiPAP, intubation, extubation, lung bronchoscopy and mechanical ventilation). In addition, there is also a need to improve the safety of the environment in which medications, such as nebulised aerosols or Metered Dose Inhalers (MDIs) or puffers, are administered to patients. There is a further need to improve the safety of the environment in which HCWs conduct heart and lung ultrasounds and auscultation, electrocardiograms (ECGs), and measure blood pressure and pulse oxygen saturation (SpO2) of a patient.

### SUMMARY OF THE INVENTION

The following presents a simplified summary of the disclosure in order to provide a basic understanding to the reader. This summary is not an extensive overview of the disclosure and it does not necessarily identify key/critical elements of the invention or delineate the scope of the invention. Its sole purpose is to present some concepts disclosed herein in a simplified form as a prelude to the more detailed description that is presented later.

The present invention provides a pressurized isolation unit dimensioned to cover the head and thoraco-abdominal region of a patient. The unit has a filtered pressure system and an abdominal binding cover, that can be flexible, that wraps around the patient's abdomen.

In one embodiment, the filtered pressure system is a filtered positive pressure system. In an alternate embodiment, the filtered pressure system is a filtered negative pressure system. Where a filtered negative pressure system is present, wall vacuum suction tubing may be used to provide negative pressure for the unit.

In some embodiments, the unit has one or more access ports. For example, the unit may have at least two access ports with sealed gloves. The unit may also have one or more access ports for use in oxygen therapy. The unit may further have one or more access ports for use with monitoring cables.

In certain embodiments, the unit may have clear viewing windows.

The unit may be made of materials that are compatible with disinfectants.

In some embodiments, the unit may have two or more stabilization bars that secure the unit to a patient bed.

### BRIEF DESCRIPTION OF THE DRAWINGS

FIG. 1 is a top view of an embodiment of a pressurized isolation unit with a patient therein.

FIG. 2 is a “head” side view of the unit of FIG. 1 with a patient therein.

FIG. 3 is a left side view of the unit of FIG. 1.

FIG. 4 is a right-side view of the unit of FIG. 1.

FIG. 5 is a cross-sectional “foot” side view of the unit of FIG. 1 with a patient therein.

FIG. 6 is a cross-sectional right-side view of the unit of FIG. 1 with a patient therein.

### DETAILED DESCRIPTION OF THE INVENTION

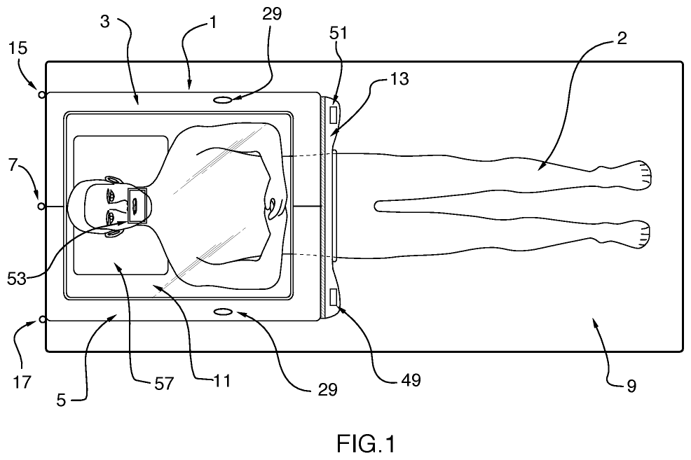

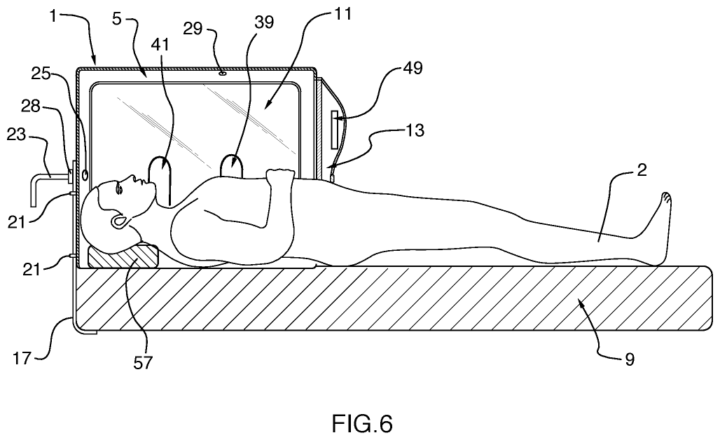

The present invention is a pressurized isolation unit. In certain embodiments, it can be a negative pressure isolation unit used in the treatment of patients infected with contagious airborne pathogens. An exemplary embodiment of negative pressure isolation unit 1 may be seen in FIGS. 1-6. As shown in FIG. 6, the unit may be positioned over the head and thoraco-abdominal region of patient 2.

Unit 1 tends to provide improved protection for HCWs dealing with a contagious aerosolized droplet pathogen. This is done in part by providing (1) a self-contained filtered negative pressure system and (2) a special abdominal binding to prevent air leaks below the patient's chest. In certain embodiments, the air inside the unit is evacuated via continuously filtered wall suction.

Unit 1 also allows for a patient to receive a wide range of care. For example, unit 1 may have airway management access ports for intubation and extubation to be performed inside the unit, which tends to protect HCWs from exposure to airborne pathogens. Oxygen therapy may be conducted inside unit 1. This includes, for e.g., the use of nasal cannula, such as high flow nasal cannula (HFNC), Ventimask™, OptiFlow™, bi-level positive airway pressure (BiPAP), continuous positive airway pressure (CPAP), and 100% non-rebreather mask. Unit 1 may also be configured to allow patients when awake to flip themselves onto their abdomen for what the skilled person would refer to as “awake prone positioning.” Mechanical ventilation can be initiated inside the unit if required. In addition, medication may be administered to a patient by, for e.g., intravenous (IV) drip or puffer, while he or she is inside unit 1. Unit 1 further tends to provide a safe environment for defibrillation and allows HCWs to perform CPR, such as by use of the Stryker LUCAS 3™ CPR system inside unit 1. Unit 1 may also allow for internal jugular (IJ) venous cannulation for IV infusions and pressure monitoring, depending on patient size and position.

As noted above, use of Unit 1 tends to provide improved protection for HCWs from exposure to airborne pathogens during procedures such as HFNC, CPAP, BiPAP, awake prone breathing, or aerosol therapy. The use of such treatment modalities may decrease the need for endotracheal intubation and mechanical ventilation. This can be beneficial as intubation is not a benign procedure. Patients are given anesthetic drugs that lower blood pressure and produce unconsciousness/paralysis. When a patient is difficult to manually ventilate or intubate, this puts the patient at a higher risk of cardiac arrest and death.

Patient vitals can be continuously monitored while the patient is in the device. As described below, unit 1 may have assessment ports to keep a patient isolated, yet still allow for hands-on evaluation of the patient through various means like auscultation and ultrasound to assess, for e.g., heart and lung condition. Unit 1 may have access ports for various physiological monitoring cables and emergency devices. This allows one to conduct ECGs, and measure patient blood pressure, SpO2 and temperature. Unit 1 may also have special access ports for video laryngoscopy cables.

Unit 1 is dimensioned to be positioned over a patient's head and thoraco-abdominal region and allows a patient to receive the range of care outlined above. In contrast with, for e.g., United States Patent Publication No. 2005/0085686 A1, unit 1 does not cover the whole of the patient's body. This means that unit 1 allows for femoral venous and arterial access in the groin for IV infusions, blood pressure monitoring and Extracorporeal Membrane Oxygenation (ECMO). Preferably, unit 1 is also dimensioned to allow a patient to position himself or herself freely. In certain embodiments, unit 1 is approximately 22″ to 26″ in height, approximately 22″ to 28″ in width and approximately 26″ to 30″ in length.

Unit 1 is preferably made of materials that are compatible with disinfectants. Unit 1 is also preferably made of lightweight materials. For e.g., unit 1 may be made of polymers such as polyethylene, polypropylene, nylon, polystyrene, polyvinyl chloride (PVC), and polyethylene terephthalate (PET). Unit 1 may be formed using rotational molding, injection molding, or blow molding.

Unit 1 is, in certain embodiments, portable and modular such that it can be easily installed or removed if required. Unit 1 can be quickly assembled by a team of two people within minutes. This is very useful for situations where immediate patient isolation is required for management of contaminated aerosolized droplets, but a negative pressure room is unavailable.

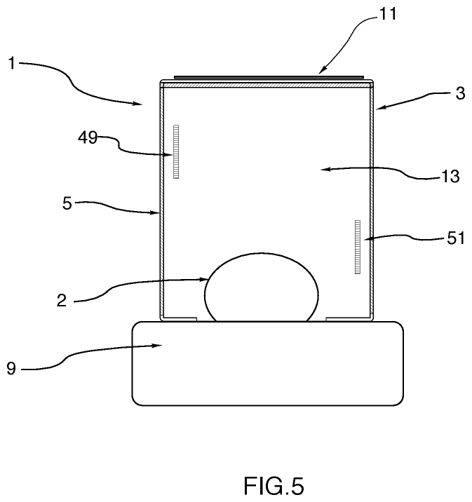

The unit may be of one-piece or unitary construction. In other embodiments, as shown in FIG. 1, unit 1 may be made of two sections, a left side 3 and right side 5. Preferably, these sections can be quickly joined together. This may be done, for e.g., via an upper/lower connection hinge 7 located near the head of bed 9. Once hinge 7 is connected, the left side 3 and right side 5 of unit 1 may, for e.g., be joined together at the top via tongue/groove joint connections, which lock the parts in place. A fastener/connector, such as Velcro™ or other hook and loop strips, may be used to join left side 3 and right side 5 to provide an airtight seal. See, for e.g., FIG. 5, where the dashed lines near left side 3, right side 5, and below viewing window 11 represent Velcro strips.

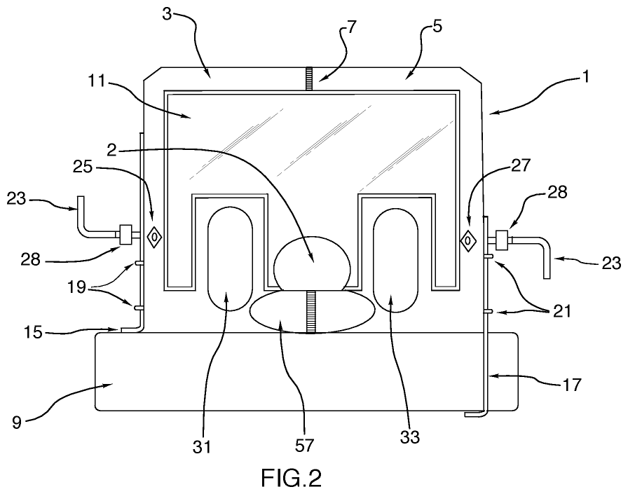

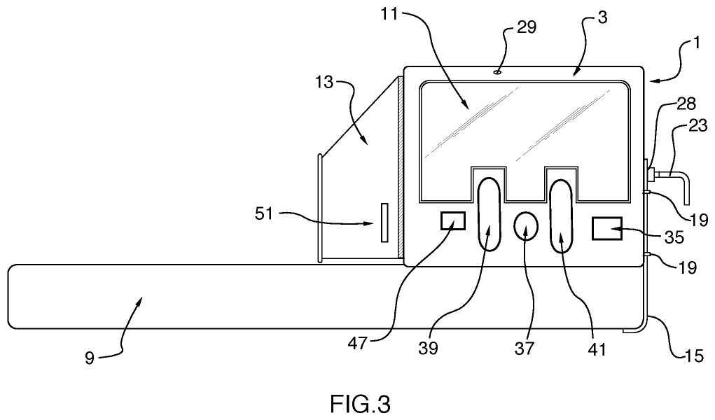

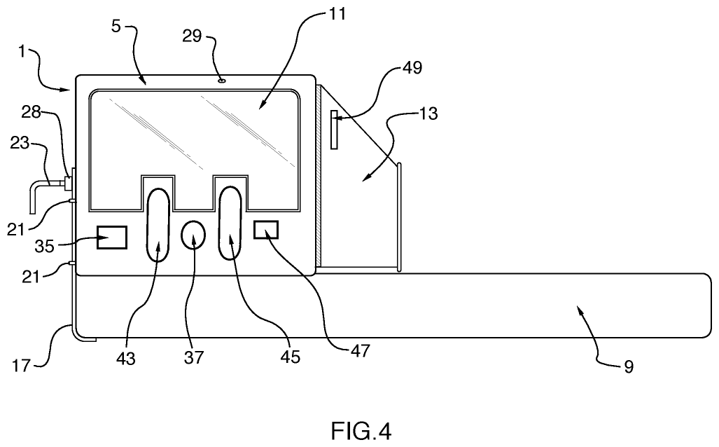

Preferably, unit 1 provides clear viewing windows 11, which tend to decrease patient anxiety and allow HCWs to quickly visually assess the patient's condition. Viewing windows 11 can, for e.g., be provided by the use of transparent sheets such as Plexiglas™ or Lexan™ sheets. Viewing windows 11 may be, for e.g., ⅜″ thick. Viewing windows 11 may be permanently attached to unit 1. For e.g., viewing windows 11 in FIGS. 3 and 4 may be permanently attached to unit 1 during the production process to decrease assembly time. In an alternate embodiment, viewing windows 11 may be inserted during assembly. For e.g., once the hinge 7 and tongue/groove connections are attached, four viewing windows 11 may be inserted into specially designed insert slots. The top of unit 1 may have a horizontal viewing window 11 which may be 24″ by 26″. The left side 3 and right side 5 and head side of unit 1, as shown in FIG. 2, may also have vertical insert slots for their respective viewing windows 11. These four sides form the foundational basic structure of unit 1 and help ensure a proper air seal once unit 1 is connected to patient wall suction.

The foot side of unit 1 has an abdominal binding cover 13 that may be wrapped around a patient's abdomen. A relatively tight seal around the abdomen may be provided, for e.g., by the use of an elastic material or Velcro™. In some embodiments, cover 13 is provided as separate from unit 1, and is connected to unit 1 via one or more Velcro™ strips. For e.g., cover 13 may be attached to unit 1 via three Velcro™ strips: a left/vertical strip, a horizontal strip and a right/vertical strip. In such embodiments, cover 13 may be provided as a disposable item. In other embodiments, cover 13 may be permanently attached to unit 1.

Once assembled, unit 1 may be positioned on the upper/superior aspect of a patient's bed and is preferably level with the upper mattress. Patient pillow 57 can be located within unit 1. The isolation unit may be secured to the superior aspect of the mattress of bed 9 via two stabilization bars 15 and 17. Bars 15 and 17 may, for example, be located at the corners of the left side 3 and right side 5 of unit 1. In certain embodiments, bars 15 and 17 extend past the mattress of bed 9 and hook underneath it. See, for e.g., FIG. 2, where bar 15 is in a retracted position, which may be used when the bed is flat, and where bar 17 is in a lowered position, which may be used when head of bed 9 is elevated. Bars 15 and 17 may be kept in place via two locking brackets 19 and 21. Brackets 19 and 21 help keep unit 1 in a stable position by securing it to the mattress bed frame. The patient's head of bed 9 can therefore be in a semi-flat position, or it can be safely elevated up to 45 degrees to help with patient management and decrease shortness of breath.

In order to provide negative pressure, wall vacuum suction tubing may be used. For e.g., two wall vacuum suction tubes 23 may be connected to two bacterial/viral filter ports 25 and 27 with bacterial/viral filters 28. Bacterial/viral filters 28 can be, for e.g., PALL Ultipor™ 100 Heat and Moisture exchanging Filter (HMEF) with 15 mm and 22 mm connections, or Intersurgical Filta-Therm™ range-high efficiency HMEF filters. Bacterial/viral filter ports 25 and 27 may be located approximately 6″ to 10″ from the bottom of unit 1. With the suction at maximum, approximately 300 L of contaminated air can be filtered and evacuated approximately every 4 minutes providing approximately 15 gas exchanges per hour. Optionally, two air inlet ports 29 may be used to provide a patient with bias flow to help stir up the air circulating in unit 1. In certain embodiments, an exterior fan may be used to blow air into unit 1. The fan is preferably located at a distance from unit 1.

Unit 1 has one or more access ports, which may be located on any side of unit 1.

As can be seen in FIG. 2, two access ports 31 and 33 allow HCWs to access a patient. Ports 31 and 33 can be used, for e.g., to provide safe airway management support including endotracheal intubation, and to administer medication to a patient. Ports 31 and 33 preferably have sealed gloves, such as sealed long medical grade disposable gloves, to allow a HCW to assist a patient while limiting the risk of exposure to any pathogens. In certain embodiments, ports 31 and 33 may, for e.g., be oval in shape, and may be about 4″ wide by 8″ high.

Left side 3 and right side 5 of unit 1 may each have multiple access ports. In certain embodiments, these access ports may be symmetrical on both left side 3 and right side 5. Special plastic or neoprene covers may be used to ensure a proper seal when the access ports are not in use. These covers tend to prevent air with contagious pathogens from escaping unit 1. In certain embodiments, the outer section of the access ports may have a small 2 cm J-shaped outer rim circumference. A band, which may be made of elastic, clear plastic, neoprene or Velcro™ may reside inside the J-groove rim and maintain the seal. Preferably, the band is latex free.

Viewing window 11 at the top of unit 1 may have a special sealed port 53 for lung bronchoscopy and cardiac transesophageal echocardiography (TEE).

There may be a physiological monitoring port 35 on both sides of unit 1. Port 35 may be used for all monitoring cables entering unit 1. These cables may be used, for e.g., for conducting an ECG or monitoring a patient's SpO2 and blood pressure.

There may also be an oxygen therapy port 37. This port can be used to provide a patient with various oxygen therapy modalities such as simple nasal cannula, HFNC-OptiFlow™, BiPAP, CPAP, and mechanical ventilation.

Unit 1 may also have two access ports 39 and 41 on left side 3 of unit 1, and two access ports 43 and 45 on right side 5 of unit 1 to help with patient nursing and respiratory care requirements, as well as to aid in patient positioning and/or assessment. These ports may also be used to assist with any urgent airway management issues. In some embodiments, these ports have sealed long medical grade disposable gloves.

In certain embodiments, there may be an assessment window 47 on each side of unit 1. These windows 47 may be used to assess the patient's heart and lung condition via ultrasound and/or auscultation. Preferably, ultrasound probes or stethoscopes are placed in plastic covers prior to use in unit 1. These covers tend to assist in preventing HCWs from contracting any pathogens.

Abdominal binding cover 13 may have two folded cylindrical plastic bags. When flattened, the dimensions of these bags can be, for e.g., approximately 4″ to 14″×15″ to 24″. The first bag, inlet bag 49, may be located to the right superior area of the patient's right hand, while the second bag, outlet bag 51, may be located just a few inches above the patient's left hand. Inlet bag 49 may be positioned high in abdominal binding cover 13 such that items, such as food, water bottles, books, phones, and medical equipment can fall into unit 1. Outlet bag 51 may be positioned low in abdominal binding cover 13, and may be used for removing items such as garbage, tissues, bandages, and facecloths. When not in use, bags 49 and 51 may be rolled up and clipped shut. Bags 49 and 51 provide a conduit for getting items into and out of unit 1, while limiting the chances of contaminated air entering the room in which the patient is located.

While intended for use in a medical facility, the skilled person will appreciate that unit 1 can be used anywhere there is a concern about the potential for transmission of airborne pathogens. In a hospital, for e.g., unit 1 may be used in an emergency room, inpatient room, intensive care unit, or operating room. Unit 1 can also be used in patient transport, whether in an ambulance (depending on stretcher location/width), or from one location to another within a hospital, provided that unit 1 is connected to a continuous portable suction device.

Use of the invention can help decrease the wait times for rooms after intubation and extubation of patients who have, or are suspected to have, contagious airborne pathogens such as COVID-19. As noted above, these procedures are AGMPs, and current standards require HCWs to wait about 20 to 35 minutes after such procedures are conducted for the air in the room to be exchanged and considered safe to proceed with surgery or to exit the operating room. The invention can greatly reduce this wait time and further protect HCWs.

In an alternate embodiment, the pressurized isolation unit can be a positive pressure isolation unit used for patients that require protection from an environment with contagious airborne pathogens. This can, for example, but used in the treatment of patients who are immunocompromised, such as HIV/AIDS patients, transplant patients (such as bone marrow or organ transplant patients), cancer patients, and patients with autoimmune diseases. In such embodiments, the unit can be set up to protect immunocompromised patients as soon as they arrive at the hospital.

In embodiments where the unit is a positive pressure isolation unit, the positive pressure environment may, for example, be attained by infusing filtered air, or a filtered air and oxygen mixture, into the unit (via wall vacuum suction tubes 23 through bacterial/viral filters 28 into bacterial/viral filter ports 25 and 27). This provides a sterile clean air environment. The skilled person will appreciate that, in comparison to the negative pressure isolation units described above, airflow will occur in the reverse direction (i.e. where in a negative pressure isolation unit, air is filtered on leaving the unit through the bacterial/viral filters in bacterial/viral filter ports, in a positive pressure isolation unit, air is instead filtered on entering the unit through the bacterial/viral filters in bacterial/viral filter ports).

The abbreviation mm as used herein refers to millimetres (or in the US, “millimeters”). The abbreviation cm as used herein refers to centimetres (or in the US, “centimeters”).

Where, in this document, a list of one or more items is prefaced by the expression “such as” or “including”, is followed by the abbreviation “etc.”, or is prefaced or followed by the expression “for example”, or “e.g.”, this is done to expressly convey and emphasize that the list is not exhaustive, irrespective of the length of the list. The absence of such an expression, or another similar expression, is in no way intended to imply that a list is exhaustive. Unless otherwise expressly stated or clearly implied, such lists shall be read to include all comparable or equivalent variations of the listed item(s), and alternatives to the item(s), in the list that a skilled person would understand would be suitable for the purpose that the one or more items are listed. Unless expressly stated or otherwise clearly implied herein, the conjunction “or” as used in the specification and claims shall be interpreted as a non-exclusive “or” so that “X or Y” is true when X is true, when Y is true, and when both X and Y are true, and “X or Y” is false only when both X and Y are false.

The words “comprises” and “comprising”, when used in this specification and the claims, are used to specify the presence of stated features, elements, integers, steps or components, and do not preclude, nor imply the necessity for, the presence or addition of one or more other features, elements, integers, steps, components or groups thereof.

It should be understood that the above-described embodiments of the present invention, particularly, any “preferred” embodiments, are only examples of implementations, merely set forth for a clear understanding of the principles of the invention. Many variations and modifications may be made to the above-described embodiment(s) of the invention as will be evident to those skilled in the art. That is, persons skilled in the art will appreciate and understand that such modifications and variations are, or will be, possible to utilize and carry out the teachings of the invention described herein.

The scope of the claims that follow is not limited by the embodiments set forth in the description. The claims should be given the broadest purposive construction consistent with the description and figures as a whole.

1. A pressurized isolation unit dimensioned to cover the head and thoraco-abdominal region of a patient, but does not extend past the patient's abdomen, the unit comprising:
a filtered pressure system; and
a flexible abdominal binding cover that wraps around the patient's abdomen.

2. The unit of claim 1, wherein the unit is about 26″ to about 30″ in length.

3. The unit of claim 1, wherein the unit is about 22″ to about 26″ in height.

4. The unit of claim 1, wherein the filtered pressure system is a filtered positive pressure system.

5. The unit of claim 1, wherein the filtered pressure system is a filtered negative pressure system.

6. The unit of claim 5, wherein wall vacuum suction tubing is used to provide negative pressure.

7. The unit of claim 1, wherein the unit further comprises one or more access ports.

8. The unit of claim 7, wherein the top of the unit has a sealed port located generally above the patient's face.

9. The unit of claim 8, wherein the sealed port is for use in lung bronchoscopy or cardiac transesophageal echocardiography (TEE).

10. The unit of claim 7, wherein the unit has at least two access ports with sealed gloves.

11. The unit of claim 7, wherein the unit has one or more access ports for use in oxygen therapy.

12. The unit of claim 7, wherein the unit has one or more access ports for use with monitoring cables.

13. The unit of claim 1, wherein the unit has clear viewing windows.

14. The unit of claim 13, wherein the top of the unit has a clear horizontal viewing window that is about 24″ in width by about 26″ in length.

15. The unit of claim 1, wherein the unit is made of materials that are compatible with disinfectants.

16. The unit of claim 1, wherein the unit further comprises two or more stabilization bars that secure the unit to a patient bed.
